(19) United States
(12) Patent Application Publication
(10) Pub. No.: US 2026/0333545 A1
(43) Pub. Date: Oct. 22, 2026

(54) RENDERING ENTERTAINMENT LIGHT EFFECTS BASED ON PREFERENCES OF THE NEAREST USER

(71) Applicant: SIGNIFY HOLDING B.V., EINDHOVEN (NL)

(72) Inventor: NIEK MARCELLUS CORNELIS MARTINUS JANSSEN, EINDHOVEN (NL)

(21) Appl. No.: 19/107,724

(22) PCT Filed: Aug. 18, 2023
(86) PCT No.: PCT/EP2023/072771

§ 371 Date: Feb. 28, 2025

(30) Foreign Application Priority Data
Aug. 29, 2022 (EP) 22192560.5

(51) Int. Cl. H05B 47/115; H05B 47/19

(52) U.S. Cl. CPC H05B 47/115; H05B 47/19

(57) ABSTRACT

A system (1) for controlling one or more lighting devices (11-12) to render light effects determined based on media content, to accompany a rendering of the media content, is configured to detect whether one or more users (77, 78) are in an environment and if multiple users are detected to be in said environment, determine which user of the multiple users is nearest to the system based on shortrange wireless signals received from mobile devices (34, 35) of the multiple users and retrieve a user profile associated with the user nearest to the system. The user profile specifies user preferences. The system is further configured to determine the light effects based on the media content and the user preferences and control the one or more lighting devices to render the light effects.

### FIELD OF THE INVENTION

The invention relates to a system for controlling one or more lighting devices to render light effects determined based on media content to accompany a rendering of said media content.

The invention further relates to a method of controlling one or more lighting devices to render light effects determined based on media content to accompany a rendering of said media content.

The invention also relates to a computer program product enabling a computer system to perform such a method.

### BACKGROUND OF THE INVENTION

In order to create a more immersive entertainment experience, systems may be used which are able to control lighting devices to change color depending on video and/or audio content. An example of such a system is the Hue system in which the audio or video can be passed through a Hue (HDMI) Sync box or generated from a desktop PC (Hue Sync PC desktop app). In these systems, the audio and/or video is analyzed, and the colors rendered by a group of lighting devices change depending on the analyzed content. In other words, the lighting devices are controlled to render entertainment light effects.

An HDMI module like the Hue Sync box sits in between HDMI devices and the TV, receiving the signal earlier than the TV and thereby enabling a seamless effect that matches what is being shown on the TV screen. The Hue Sync box controls the group of lighting device to render entertainment light effects based on the relative positions of the lighting devices in the users' room, which a user has indicated during the creation of a so-called entertainment area. During this process, the user can select several lighting devices and drag and drop them in a 3D visualization of a room.

When syncing with content with the Hue Sync box, multiple personalization options are available to users. Users can change brightness, which basically dims down the lighting devices across the entire entertainment area, i.e. reduces their light output levels. Separately, users can change intensity mode: a selection of four options ranging from “subtle” to “extreme” which correspond to different levels of dynamicity of the light effects. With the “subtle” setting, effects only happen occasionally on drastic changes within the content (e.g., from blue to orange color) whereas with the “extreme” setting, the lighting devices react to any (minor) change within the content.

Other than the brightness and intensity mode, users are also able to select options like the HDMI input with which to sync and advanced settings like a minimum light output level, which determines whether lights go off when the screen turns dark. Last, a user is able to choose between various earlier mentioned entertainment areas encompassing of a selection of lights the effect occurs on. With so many choices, the users have a lot to set up initially. The Hue Sync box does store the last used settings, but considering that there are many multi-person households, users of the Hue sync box often change their settings before or during their sync session, because they are not satisfied with the defaults from the previous session and previous user.

Users find it cumbersome to change their settings this often. Asking a user to manually select a user profile would be an improvement but still cumbersome as the app would always be needed to make the necessary selection. Automatic selection of a user profile would be preferable.

Automatic selection of a TV user profile is known. For example, US2016/037225 A1 discloses detecting a Bluetooth terminal, determining whether the priority order of the detected terminal is higher than the priority order of the presently set profile, and if so, ask whether to load the profile of the detected terminal. After this profile has been loaded, user viewing conditions (e.g. favorite channel, volume) are set based on the loaded profile. It is a drawback of this method that assigning priorities to users is still cumbersome.

### SUMMARY OF THE INVENTION

It is a first object of the invention to provide a system, which is able to determine entertainment light effects based on an automatically selected user profile and control one or more lighting devices to render these entertainment light effects.

It is a second object of the invention to provide a method, which can be used to determine entertainment light effects based on an automatically selected user profile and control one or more lighting devices to render these entertainment light effects.

In a first aspect of the invention, a system for controlling one or more lighting devices to render light effects determined based on media content to accompany a rendering of said media content comprises at least one receiver, at least one transmitter, and at least one processor configured to detect whether one or more users are in an environment, if multiple users are detected to be in said environment, determine which user of said multiple users is nearest to said system based on shortrange wireless signals received, via said at least one receiver, from mobile devices of said multiple users, retrieve, from a memory, a user profile associated with said user nearest to said system, said user profile specifying user preferences, determine said light effects based on said media content and said user preferences, and control, via said at least one transmitter, said one or more lighting devices to render said light effects.

The user nearest to the system will in many cases be the user who is watching and/or listening to the media content and therefore the user for whom the light effects are intended. For example, this user may be the person turning on the system (and the TV, if the system is different from the TV), or the person sitting on the couch close to a Home theatre setup which includes the system. If the system is not controlled by a user with their mobile device, then selecting the user profile of the user nearest to the system is in many cases a good solution. However, since determining which user is nearest to the system based on shortrange wireless signals received from mobile devices of the users takes some time and consumes a non-negligible amount power if performed continuously, it is beneficial to first detect whether one or more users are at home and only determine which user is nearest to the system if multiple users are detected to be at home.

For example, if the system is an HDMI module like the Hue sync box, the HDMI module may understand, e.g. using Wi-Fi and device usage, if and how many people of the household are in an environment (e.g. at home). Alternatively multi-user geofencing may be used to detect who is in the environment (e.g. at home), e.g. by detecting who has arrived home over time and/or who has left home over time. In case of multiple people being in said environment, the HDMI module may perform the next step of determining which user is more likely to have turned the HDMI module on or to have caused the HDMI module to turn on. A shortrange wireless technology like Bluetooth may then be used to scan for smart phones in the area to identify people near the HDMI module when it turns on. The person near the HDMI module may then be identified and this person's profile, including their preferred settings, may then be loaded.

Said shortrange wireless signals may be Bluetooth signals or Zigbee signals, for example. Said user preferences may, for example, indicate one or more of: a level of dynamicity of said light effects, a light output level of said light effects, a minimum light output level, said one or more lighting devices to be used for rendering said light effects, and a (e.g. HDMI) source which provides said media content.

Said at least one processor may be configured to receive, via said at least one receiver, absolute locations of a plurality of mobile devices, compare said absolute locations of said plurality of mobile devices with an absolute location of said environment, and for each mobile device of said plurality of mobile devices which has an absolute location in a predefined spatial area around said absolute location of said environment, determine that a user of said mobile device is in said environment. For example, existing technologies implementing Geofencing may be used, e.g. the Hue Home and Away feature. This feature works even if users are in said environment (e.g. at home) but not connected to the (home) network, as long as the absolute locations of their mobile devices can be obtained. If the Hue Home and Away feature is used, users need to have access to the Hue cloud.

Said at least one processor may be configured to identify a (home) network to which said system is connected, detect whether one or more of a plurality of mobile devices are connected to said (home) network, and for each mobile device of said plurality of mobile devices which is connected to said (home) network, determine that a user of said mobile device is at in said environment. Technologies are known that detect whether a first device and a second device are connected to the same network and only allow the second device to be controlled by the first device if both devices are connected to the same network. These same technologies may be used for determining which user profile to select. These technologies work even if users have disabled location services on their mobile phones, e.g. for privacy reasons.

Said at least one processor may be configured to determine a signal strength of each of said shortrange wireless signals received from said mobile devices of said multiple users, select a mobile device from said mobile devices of said multiple users, said signal received from said selected mobile device having a highest signal strength of said signal strengths, and determine that a user of said selected mobile device is nearest to said system. This is beneficial, as signal strength reduces with distance. When the user is in another room, the walls or ceilings may additionally reduce signal strength, but it is less likely that a user who is watching and/or/listening to the content (and perceiving the entertainment light effects) is in another room than the system.

Said at least one processor may be configured to receive, via said at least one receiver, a control signal from a further mobile device of a further user of said multiple users, said control signal comprising a command to start rendering said light effects, select said further user instead of said user nearest to said system, retrieve a further user profile associated with said further user, said further user profile specifying further user preferences, determine said light effects based on said media content and said further user preferences, and control, via said at least one transmitter, said one or more lighting devices to render said light effects. While this is typically not possible if the syncing starts automatically or if the user uses a voice assistant to control the system, if the user uses their mobile device to control the system, it may be possible to determine more accurately who is watching and/or/listening to the content and select the corresponding user profile.

Said at least one processor may be configured to transmit, via said at least one transmitter, a notification to a mobile device of said user nearest to said system, said notification notifying said user that said user's user profile is now active. This notification may be provided to the user via an app, for example. This notification allows a user to take action if the wrong user profile has been automatically selected.

Said at least one processor may be configured to receive, via said at least one receiver, a second control signal from said mobile device of said user nearest to said system, said second control signal identifying another user, select said other user instead of said user nearest to said system, retrieve another user profile associated with said other user, said other user profile specifying other user preferences, determine said light effects based on said media content and said other user preferences, and control, via said at least one transmitter, said one or more lighting devices to render said light effects. Thus, the notification may be used to confirm whether the person that is recognized is indeed the user for whom the entertainment light effects are intended. If not, the person that is recognized is able to select a different profile manually. Alternatively, the user for whom the light effects are intended may be able to select a different profile manually.

Instead of using a notification to confirm whether the person that is recognized is indeed the user for whom the entertainment light effects are intended, machine learning may be used to identify situations in which the user profile of the user nearest to the system should not be selected. For example, if a different user profile is often selected manually instead of the automatically selected user profile of the nearest user when a certain user is nearest to the system, e.g. under certain circumstances, the system may learn not to select the user profile of this user automatically, e.g. under these certain circumstances. For instance, the system may learn that the user profile of the nearest user should not be selected if a voice assistant is used to control the system and the nearest user is a certain user (who does not use voice assistants).

Said user profile may specify user preferences per content type and said at least one processor may be configured to obtain a content type of said media content, select user preferences associated with said content type from said user profile, and determine said light effects based on said media content and said user preferences associated with said content type. For example, a user may prefer different settings, e.g. a higher level of dynamicity, for music than for video or games. The content type may be determined based on metadata associated with the content, for example.

Said at least one processor may be configured to receive a configuration signal from said mobile device of said user nearest to said system, said configuration signal indicating an adjustment to said user preferences, adjust said user preferences in said user profile based on said configuration signal, determine said light effects based on said media content and said adjusted user preferences, and replace said user profile with said adjusted user profile in said memory. This allows the user to easily adjust the user preferences in the user profile without having to manually select the user profile.

Said at least one processor may be configured to receive, via said at least one receiver, a device identifier of said mobile device of said user nearest to said system, and retrieve said user profile associated with said user by retrieving a user profile associated with said device identifier. This will work in many practical situations, as a mobile device often only has one user. Existing device identifiers, e.g. Bluetooth device identifiers, may be used for example. In this case, it is not required to share user information.

In a second aspect of the invention, a method of controlling one or more lighting devices to render light effects determined based on media content to accompany a rendering of said media content comprises detecting whether one or more users are in an environment, if multiple users are detected to be at in said environment, determining which user of said multiple users is nearest to said system based on shortrange wireless signals received from mobile devices of said multiple users, retrieving a user profile associated with said user nearest to said system, said user profile specifying user preferences, determining said light effects based on said media content and said user preferences, and controlling said one or more lighting devices to render said light effects. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for controlling one or more lighting devices to render light effects determined based on media content to accompany a rendering of said media content.

The executable operations comprise detecting whether one or more users are in an environment, if multiple users are detected to be in said environment, determining which user of said multiple users is nearest to said system based on shortrange wireless signals received from mobile devices of said multiple users, retrieving a user profile associated with said user nearest to said system, said user profile specifying user preferences, determining said light effects based on said media content and said user preferences, and controlling said one or more lighting devices to render said light effects.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 illustrates the operation of the system of FIG. 1 in an example situation;

FIG. 3 is a block diagram of a second embodiment of the system;

FIG. 4 is a flow diagram of a first embodiment of the method;

FIG. 5 is a flow diagram of a second embodiment of the method;

FIG. 6 is a flow diagram of a third embodiment of the method;

FIG. 7 is a flow diagram of a fourth embodiment of the method;

FIG. 8 is a flow diagram of a fifth embodiment of the method;

FIG. 9 is a flow diagram of a sixth embodiment of the method; and

FIG. 10 is a block diagram of an exemplary data processing system for performing the method of the invention.

Corresponding elements in the drawings are denoted by the same reference numeral.

### DETAILED DESCRIPTION OF THE EMBODIMENTS

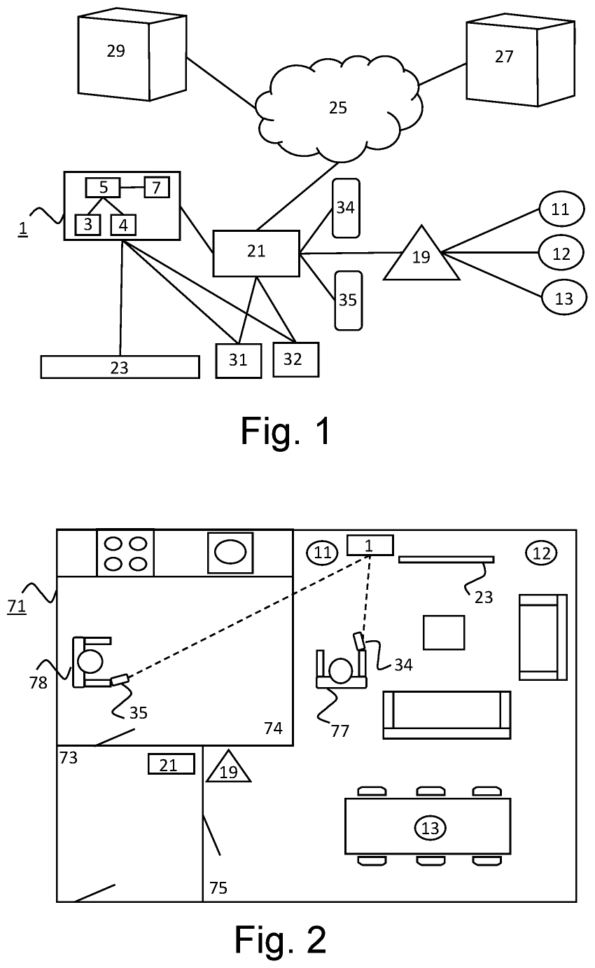

FIG. 1 shows a first embodiment of the system for controlling one or more lighting devices located in an environment to render light effects determined based on media content to accompany a rendering of the media content. In the first embodiment of FIG. 1, the system is an HDMI module 1. The HDMI module 1 may be a Hue Play HDMI Sync Box, for example.

In the example of FIG. 1, The HDMI module 1 can control lighting devices 11-13 via a bridge 19. The bridge 19 may be a Hue bridge, for example. The bridge 19 communicates with the lighting devices 11-13, e.g., using Zigbee technology. The HDMI module 1 is connected to a wireless LAN access point 21, e.g., via Wi-Fi. The bridge 19, local media receivers 31 and 32, and mobile devices 34 and 35, are also connected to the wireless LAN access point 21, e.g., via Wi-Fi or Ethernet.

Alternatively or additionally, the HDMI module 1 may be able to communicate directly with the bridge 19, e.g. using Zigbee technology, and/or may be able to communicate with the bridge 19 via the Internet/cloud, e.g. via Internet server 29. Alternatively or additionally, the HDMI module 1 may be able to control the lighting devices 11-13 without a bridge, e.g. directly via Wi-Fi, Bluetooth or Zigbee or via the Internet/cloud.

The wireless LAN access point 21 is connected to the Internet 25. A media server 27 is also connected to the Internet 25. Media server 27 may be a server of a video-on-demand service such as Netflix, Amazon Prime Video, Hulu, Disney+, or Apple TV+, for example. The HDMI module 1 is connected to a display device 23 and local media receivers 31 and 32 via HDMI. The local media receivers 31 and 32 may comprise one or more streaming or content generation devices, e.g., an Apple TV, Microsoft Xbox and/or Sony Play Station, and/or one or more cable or satellite TV receivers.

The mobile device 34 and/or the mobile device 35 may be used for controlling and configuring the HDMI module 1. For example, the user may be able define an entertainment area by using an app. In the example of FIG. 1, the user has included lighting devices 11 and 12 in the entertainment area. This entertainment area may be defined in the user preferences or may be user-independent. Only the lighting devices included in the entertainment area are controlled to render entertainment light effects.

A user profile with user preferences may be created manually and/or automatically. For example, after the user has defined the entertainment area, the user may be brought to the main user interface of the HDMI module 1 in the app. There the user may be given the option to create a profile. Within that profile, the user may be able to select their preferred settings per content category, e.g. music, video, and/or gaming. Options within each category may vary from brightness, minimum background lighting level and intensity modes, to preferred HMDI channel and entertainment area.

If users do not create a profile manually, e.g. because they do not want to or are not able to, the HDMI module 1 or app does this automatically based on the settings that the user selects within the user's entertainment session. The selected settings are then stored in the automatically created profile.

The HDMI module 1 comprises a receiver 3, a transmitter 4, a processor 5, and memory 7. The processor 5 is configured to detect whether one or more users are in said environment (e.g. a home, a room or area in a building, etc.), and if multiple users are detected to be in said environment, determine which user of the multiple users is nearest to the HDMI module 1 based on shortrange wireless signals received, via the receiver 3, from mobile devices 34 and 35 of the multiple users.

The processor 5 is further configured to retrieve, e.g. from memory 7 or from a memory of Internet server 29, a user profile associated with the user nearest to the HDMI module 1. The user profile specifies user preferences. These user preferences may indicate, for example, one or more of: a level of dynamicity of the light effects, a light output level of the light effects, a minimum light output level, the one or more lighting devices located in said environment to be used for rendering the light effects (lighting devices 11 and 12 in the example of FIG. 1), and a (e.g. HDMI) source which provides the media content.

The processor 5 is further configured to determine the light effects based on the media content and the user preferences and control, via the transmitter 4, lighting devices 11 and 12 to render the (entertainment) light effects.

Thus, the user does not need to select the correct user profile manually, but the HDMI module 1 selects the correct user profile automatically. For example, after the user profile has been created and the user's preferences have been stored therein, the subsequent time the user enters the user's home, the HDMI module 1 is notified that the user is at home. The HDMI module 1 then checks whether a single or multiple users have been detected to be at home. If a single user is detected to be at home, the HDMI module 1 retrieves the preferences in the profile of that user. If multiple users are detected to be at home, an additional check is performed e.g. via Bluetooth to determine which user is in closest proximity of the HDMI module 1. The HDMI module 1 then retrieves the preferences in the profile of the user in closest proximity of the HDMI module 1.

The retrieved preferences are automatically used when the HDMI module 1 starts syncing with HDMI content. The user is optionally asked to confirm via the app if indeed the correct user profile is loaded. A user may be able to configure whether they wish the HDMI module 1 to automatically switch to the user's profile once the user is detected to be in proximity or to (only) select the user's profile manually.

The processor 5 may be configured to receive, via the receiver 3, absolute locations of a plurality of mobile devices, e.g. from the Internet server 29, compare the absolute locations of the plurality of mobile devices with an absolute location of the environment (e.g. the home), and for each mobile device of the plurality of mobile devices which has an absolute location in a predefined spatial area around the absolute location of the environment, determine that a user of the mobile device is in said environment.

For example, four users with each their own mobile device may have been configured in the lighting system. Two of these mobile devices are not located in said environment and two of these mobile devices, i.e. mobile devices 34 and 35, are located in said environment. The absolute location of the environment may be retrieved from the memory 7 or from the Internet server 29, for example. The absolute location of a home may have been input by a user.

Alternatively or additionally, the processor 5 may be configured to identify a (home) network to which the system is connected (either directly or indirectly), detect whether one or more of a plurality of mobile devices are connected to the (home) network, and for each mobile device of the plurality of mobile devices which is connected to the (home) network, determine that a user of the mobile device is at said environment.

For example, four users with each their own mobile device may have been configured in the lighting system. Two of these mobile devices are not connected to the (home) network, e.g. connected only via a cellular network or not connected, and two of these mobile devices, i.e. mobile devices 34 and 35, are connected to the (home) network. In the example of FIG. 1, the HDMI module 1 is connected directly to the wireless LAN access point 21. Alternatively, the HDMI module 1 may be connected indirectly to the (home) network via the bridge 19.

In the embodiment of FIG. 1, the processor 5 is configured to determine a signal strength of each of the shortrange wireless signals received from the mobile devices of the multiple users, select a mobile device whose received signal has a highest signal strength of the signal strengths, and determine that a user of the selected mobile device is nearest to the HDMI module 1. In an alternative embodiment, it is determined in a different manner which user of the multiple users is nearest to the HDMI module 1 based on shortrange wireless signals received from mobile devices of the multiple users.

The selected mobile device or each mobile device may transmit information identifying the user of the mobile device. The processor 5 may be configured to retrieve the user profile associated with this user identifier. Alternatively, the selected mobile device or each mobile device may transmit a device identifier. The processor 5 may be configured to retrieve the user profile associated with this device identifier. This will work in many practical situations, as a mobile device often only has one user. Existing device identifiers, e.g. Bluetooth device identifiers, may be used for example. When a new device identifier is detected, a new user profile may be created automatically, e.g. with system-default preferences or the last used preferences, and then linked to this new device identifier.

FIG. 2 illustrates the operation of the system of FIG. 1 in an example situation. FIG. 2 shows an example of a floorplan of a home 71 in which the HDMI module 1 of FIG. 1 is used. Three rooms are depicted: a hall 73, a kitchen 74 and a living room 75. The wireless LAN access point 21 of FIG. 1 has been placed in the hall 73. The HDMI module 1, the bridge 19, the display device 23, and the lighting devices 11-13 of FIG. 1 have been placed in the living room 75. The HDMI module 1 has been placed near the display device 23, as it normally would, in order to limit the required length of the HDMI cable between the HDMI module 1 and the display device 23. In an alternative embodiment, the functionality of the HDMI module 1 is integrated into the display device 23.

The user 77 is holding mobile device 34 of FIG. 1. The user 78 is holding mobile device 35 of FIG. 1. If the user 77 uses their mobile device 34 to control the HDMI module 1, the user profile associated with user 77 is retrieved and used. If the user 78 uses their mobile device 35 to control the HDMI module 1, the user profile associated with user 78 is retrieved and used.

If the user 77 or the user 78 uses a voice command to control the HDMI module 1, then the HDMI module 1 does not know which user is controlling the HDMI module 1. The HDMI module 1 then determines that mobile device 34 is closest to the HDMI module 1, assumes that user 77 is controlling the HDMI module 1, and retrieves and uses the user profile associated with user 77.

If the HDMI module 1 detects without any user command that the rendering of the entertainment light effects should be started, e.g. detects that the TV has switched on or detects that an input signal is being received, then the HDMI module 1 does not know which user is watching the display device 23 (and perceiving the entertainment light effects). The HDMI module 1 then determines that mobile device 34 is closest to the HDMI module 1, assumes that user 77 is watching the display device 23, and retrieves and uses the user profile associated with user 77.

In the embodiment of the HDMI module 1 shown in FIG. 1, the HDMI module 1 comprises one processor 5. In an alternative embodiment, the HDMI module 1 comprises multiple processors. The processor 5 of the HDMI module 1 may be a general-purpose processor, e.g. ARM-based, or an application-specific processor. The processor 5 of the HDMI module 1 may run a Unix-based operating system for example. The memory 7 may comprise one or more memory units. The memory 7 may comprise solid-state memory, for example.

The receiver 3 and the transmitter 4 may use one or more wired or wireless communication technologies such as Zigbee to communicate with the bridge 19 and HDMI to communicate with the display device 23 and with local media receivers 31 and 32, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The HDMI module 1 may comprise other components typical for a network device such as a power connector. The invention may be implemented using a computer program running on one or more processors.

In the embodiment of FIG. 1, the system of the invention comprises a single device. In an alternative embodiment, the system comprises multiple devices. In the embodiment of FIG. 1, the system of the invention is an HDMI module. In an alternative embodiment, the system may be another device, e.g., a mobile device, laptop, personal computer, a bridge, a media rendering device, a streaming device, or an Internet server. If the system is a media rendering device, e.g. a display device, the above-described HDMI module logic may be incorporated into the device. Media receivers 31 and 32 may then also be comprised in the media rendering device, e.g., a smart TV.

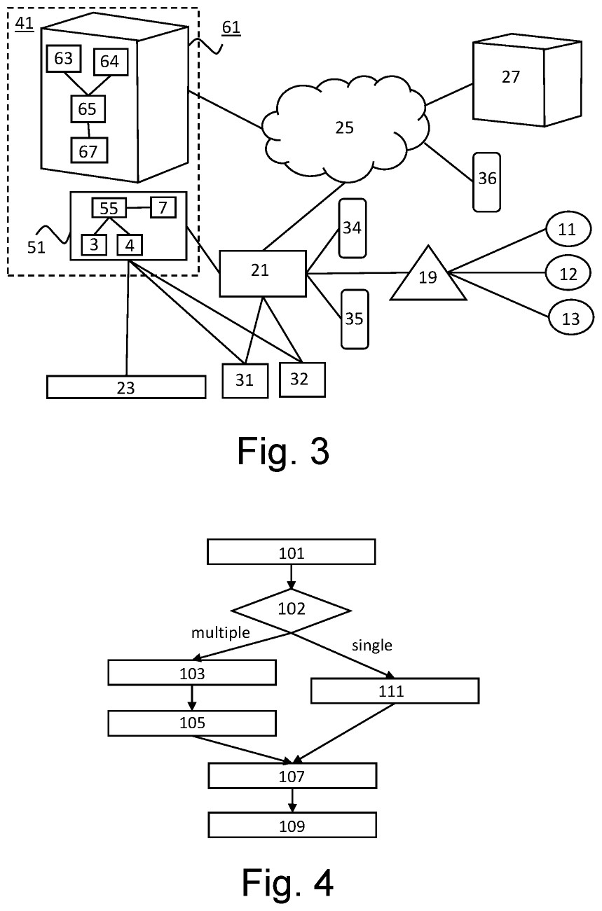

FIG. 3 shows a second embodiment of the system for controlling one or more lighting devices to render light effects determined based on media content to accompany a rendering of the media content. In the second embodiment of FIG. 3, the system is a lighting system 41. The lighting system 41 comprises an HDMI module 51 and a cloud computer 61. The computer 61 may be operated by a lighting company, for example.

The computer 61 comprises a receiver 63, a transmitter 64, a processor 65, and a memory 67. The processor 65 is configured to receive, via the receiver 63, absolute locations of a plurality of mobile devices, the absolute locations of the plurality of mobile devices with an absolute location of the environment (e.g. home), and for each mobile device of the plurality of mobile devices which has an absolute location in a predefined spatial area around the absolute location of the environment, determine that a user of the mobile device is at environment.

The absolute location of the environment may be retrieved from the memory 67, for example. The absolute location of the environment may have been input by a user. The absolute locations may be received from the mobile devices themselves, for example. The processor 65 is further configured to transmit information to the HDMI module 1 indicating whether one or more users are at the environment.

The HDMI module 51 comprises a receiver 3, a transmitter 4, a processor 55, and memory 7. The processor 55 is configured to detect, based on the information received from cloud computer 61, whether one or more users are in an environment, and if multiple users are detected to be in said environment, determine which user of the multiple users is nearest to the HDMI module 51 based on shortrange wireless signals received, via the receiver 3, from mobile devices 34 and 35 of the multiple users. The processor 55 is further configured to retrieve, e.g. from memory 57 or from memory 67, a user profile associated with the user nearest to the HDMI module 1. The user profile specifies user preferences. The processor 55 is further configured to determine the light effects based on the media content and the user preferences and control, via the transmitter 54, lighting devices 11 and 12 to render the (entertainment) light effects.

In the embodiment of the HDMI module 51 shown in FIG. 3, the HDMI module 51 comprises one processor 55. In an alternative embodiment, the HDMI module 51 comprises multiple processors. The processor 55 of the HDMI module 51 may be a general-purpose processor, e.g. ARM-based, or an application-specific processor. The processor 55 of the HDMI module 51 may run a Unix-based operating system for example. The HDMI module 51 may comprise other components typical for a network device such as a power connector. The invention may be implemented using a computer program running on one or more processors.

In the embodiment of the computer 61 shown in FIG. 3, the computer 61 comprises one processor 65. In an alternative embodiment, the computer 61 comprises multiple processors. The processor 65 of the computer 61 may be a general-purpose processor, e.g. from Intel or AMD, or an application-specific processor. The processor 65 of the computer 61 may run a Windows or Unix-based operating system for example. The storage means 67 may comprise one or more memory units. The memory 67 may comprise one or more hard disks and/or solid-state memory, for example. The memory 67 may be used to store an operating system, applications and application data, for example.

The receiver 63 and the transmitter 64 may use one or more wired and/or wireless communication technologies such as Ethernet and/or Wi-Fi (IEEE 802.11) to communicate with the wireless LAN access point 21, for example. In an alternative embodiment, multiple receivers and/or multiple transmitters are used instead of a single receiver and a single transmitter. In the embodiment shown in FIG. 3, a separate receiver and a separate transmitter are used. In an alternative embodiment, the receiver 63 and the transmitter 64 are combined into a transceiver. The computer 61 may comprise other components typical for a computer such as a power connector. The invention may be implemented using a computer program running on one or more processors.

A first embodiment of the method of controlling one or more lighting devices to render light effects determined based on media content to accompany a rendering of the media content is shown in FIG. 4. The method may be performed by the HDMI module 1 of FIG. 1 or the lighting system 41 of FIG. 3, for example.

A step 101 comprises detecting whether one or more users are in an environment. A step 102 comprising checking, based on the results of step 101, whether a single user is detected to be in said environment or multiple users are detected to be in said environment. If it is determined in step 102 that multiple users are detected to be in said environment, then a step 103 is performed next. If it is determined in step 102 that a single user is detected to be in said environment, then a step 111 is performed next.

Step 103 comprises determining which user of the multiple users is nearest to the system based on shortrange wireless signals received from mobile devices of the multiple users. The shortrange wireless signals may be Bluetooth signals or Zigbee signals, for example. Next, a step 105 comprises retrieving a user profile associated with the user nearest to the system, as determined in step 103. Step 111 comprises retrieving a user profile associated with the single user detected to be in said environment in step 101.

The user profile retrieved in step 105 or step 111 specifies user preferences. These user preferences may indicate, for example, one or more of: a level of dynamicity of the light effects, a light output level of the light effects, a minimum light output level, the one or more lighting devices to be used for rendering the light effects, and a source which provides the media content.

A step 107 comprises determining the light effects based on the media content and the user preferences retrieved in step 105 or step 111. For example, in step 107, an average color may be extracted from one or more video frames at each video frame of the content. The number of frames from which the average color is extracted may depend on the user preferences. The light output level of the light effects may (also) depend on the user preferences, for example. A step 109 comprises controlling the one or more lighting devices to render the light effects determined in step 107.

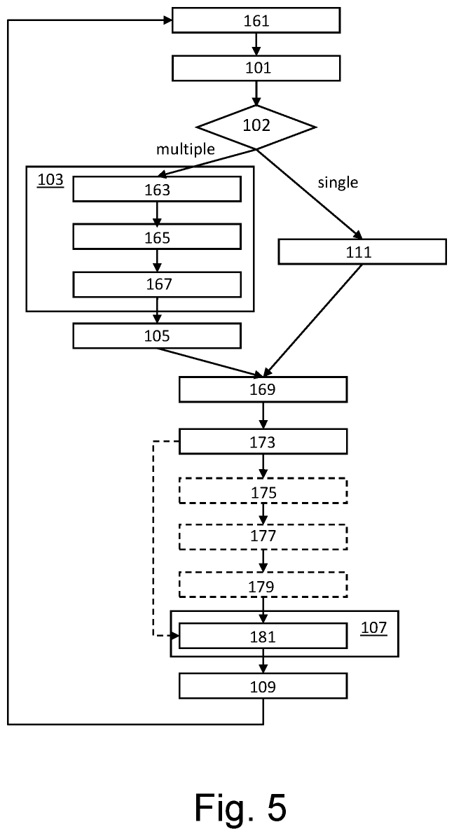

A second embodiment of the method of controlling one or more lighting devices to render light effects determined based on media content to accompany a rendering of the media content is shown in FIG. 5. The method may be performed by the HDMI module 1 of FIG. 1 or the lighting system 41 of FIG. 3, for example. The second embodiment of FIG. 5 is an extension of the first embodiment of FIG. 4.

A step 161 comprises obtaining a content type of the media content. Step 101 comprises detecting whether one or more users are in an environment. A step 102 comprising checking, based on the results of step 101, whether a single user is detected to be in said environment or multiple users are detected to be in said environment. If it is determined in step 102 that multiple users are detected to be in said environment, then a step 103 is performed next. If it is determined in step 102 that a single user is detected to be in said environment, then a step 111 is performed next.

Step 103 comprises determining which user of the multiple users is nearest to the system based on shortrange wireless signals received from mobile devices of the multiple users. In the embodiment of FIG. 5, step 103 is implemented by steps 163, 165, and 167. Step 163 comprises determining per mobile device a signal strength of at least one shortrange wireless signal received from the mobile device. Optionally, if multiple shortrange wireless signals are received from a single mobile device, an average signal strength of these multiple shortrange wireless signal may be determined. Step 165 comprises selecting the mobile device of which the signal has the highest (average) signal strength. Step 167 comprises determining that a user of the mobile device selected in step 165 is nearest to the system.

Next, step 105 comprises retrieving a user profile associated with the user nearest to the system, as determined in step 103. Step 111 comprises retrieving a user profile associated with the single user detected to be in said environment in step 101. The user profile retrieved in step 105 or step 111 specifies user preferences per content type. A step 169 comprises selecting user preferences associated with the content type obtained in step 161 from the user profile retrieved in step 105 or step 111.

A step 173 comprises transmitting a notification to the mobile device of the user nearest to the system, as determined in step 103, or to the mobile device of the single user detected in step 101. This notification notifies the user that the user's user profile is now active.

Steps 175, 177, and 179 are optionally performed after step 173. Step 175 comprises receiving a configuration signal from the mobile device to which the notification was transmitted in step 173. The configuration signal indicates an adjustment to the user preferences. Step 177 comprises adjusting the user preferences in the user profile based on the configuration signal received in step 173. Step 179 comprises replacing the user profile with the user profile adjusted in step 177, e.g. in local memory or on a server. Step 107 is performed after step 179. If no configuration signal is received, then step 107 is performed directly after step 173.

Step 107 of FIG. 4 is implemented by a step 181. Step 181 comprises determining the light effects based on the media content and the user preferences selected in step 169, which are associated with the content type of the media content. If steps 175-179 were performed, the light effects are determined in step 181 based on the user preferences adjusted in step 177. Step 109 comprises controlling the one or more lighting devices to render the light effects determined in step 107. Step 161 is repeated after step 109 and the method then proceeds as shown in FIG. 5.

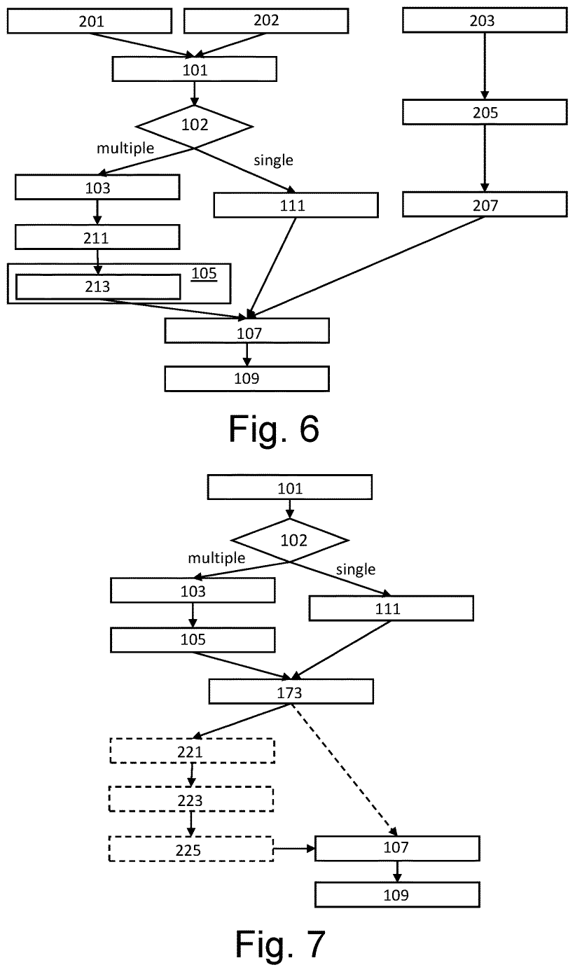

A third embodiment of the method of controlling one or more lighting devices to render light effects determined based on media content to accompany a rendering of the media content is shown in FIG. 6. The method may be performed by the HDMI module 1 of FIG. 1 or the lighting system 41 of FIG. 3, for example. The third embodiment of FIG. 6 is an extension of the first embodiment of FIG. 4.

A step 201 comprises detecting without any user command that the rendering of the light effects should be started, e.g. detecting that the TV has switched on or detecting that an input signal is being received. A step 202 comprises receiving a voice command requesting the rendering of the light effects to be started, e.g. via a smart speaker system.

Step 101 is performed after, and if, step 201 or step 202 is performed. Step 101 comprises detecting whether one or more users are in said environment. A step 102 comprising checking, based on the results of step 101, whether a single user is detected to be in said environment or multiple users are detected to be in said environment. If it is determined in step 102 that multiple users are detected to be in said environment, then a step 103 is performed next. If it is determined in step 102 that a single user is detected to be in said environment, then step 111 is performed next.

Step 103 comprises determining which user of the multiple users is nearest to the system based on shortrange wireless signals received from mobile devices of the multiple users. Next, a step 211 comprises receiving a device identifier of the mobile device of the user determined to be nearest to the system in step 103, e.g., after transmitting a request for this device identifier to this mobile device. In an alternative embodiment, step 211 is performed before step 103 or as part of step 103 and the shortrange wireless signals received from the mobile devices comprise the device identifiers of the mobile devices. Next, step 213 comprises retrieving a user profile associated with the device identifier received in step 211. Step 213 implements step 105 of FIG. 4. Step 111 comprises retrieving a user profile associated with the single user detected to be in said environment in step 101.

A step 203 comprises receiving, for a mobile device, a control signal which comprises a command to start rendering the light effects. Step 205 is performed after, and if, step 203 is performed. Step 205 comprises selecting the user of the mobile device from which the control signal was received in step 203. The mobile device from which the control signal was received in step 203 might not be the mobile device nearest to the system. Thus, the user selected in step 205 might not be the user of the mobile device nearest to the system. Next, a step 207 comprises retrieving a user profile associated with the user selected in step 205.

The user profile retrieved in step 105, step 111, or step 207 specifies user preferences. Step 107 comprises determining the light effects based on the media content and the user preferences retrieved in step 105, step 111, or step 207. Step 109 comprises controlling the one or more lighting devices to render the light effects determined in step 107.

A fourth embodiment of the method of controlling one or more lighting devices to render light effects determined based on media content to accompany a rendering of the media content is shown in FIG. 7. The method may be performed by the HDMI module 1 of FIG. 1 or the lighting system 41 of FIG. 3, for example. The fourth embodiment of FIG. 7 is an extension of the first embodiment of FIG. 4.

In the embodiment of FIG. 7, step 173 is performed after step 105 or step 111 of FIG. 4 has been performed. Step 173 comprises transmitting a notification to the mobile device of the user nearest to the system, as determined in step 103, or to the mobile device of the single user detected in step 101. This notification notifies the user that the user's user profile is now active.

Steps 221, 223, and 225 are optionally performed after step 173 in the embodiment of FIG. 7. Step 221 comprises receiving, from the mobile device to which the notification was transmitted in step 173, a control signal identifying another user. Step 223 comprises selecting the other user identifying in the control signal received in step 221. Step 225 comprises retrieving a user profile associated with the other user selected in step 223. This user profile specifies user preferences of the other user.

Step 107 is performed after step 225 has been performed. If no control signal identifying another user is received, then step 107 is performed directly after step 173. Step 107 comprises determining the light effects based on the media content and the user preferences retrieved in step 105, step 111, or step 225.

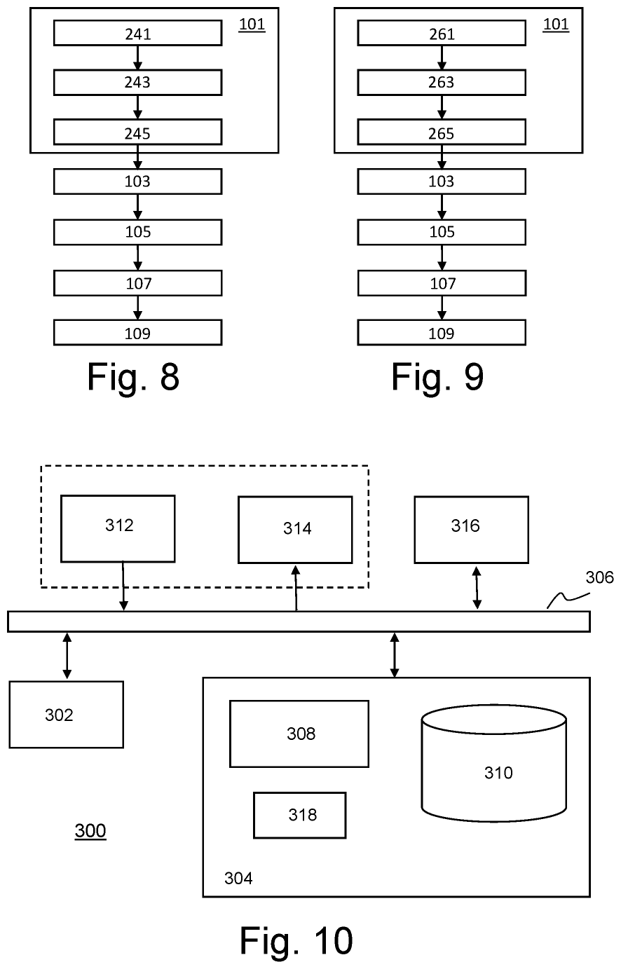

A fifth embodiment of the method of controlling one or more lighting devices to render light effects determined based on media content to accompany a rendering of the media content is shown in FIG. 8. The method may be performed by the HDMI module 1 of FIG. 1 or the lighting system 41 of FIG. 3, for example.

Step 101 comprises detecting whether one or more users are in an environment. Step 101 is implemented by steps 241, 243, and 245. Step 241 comprises receiving absolute locations of a plurality of mobile devices. Step 243 comprises comparing the absolute locations of the plurality of mobile devices, as received in step 241, with an absolute location of the home. Step 245 comprises determining, based on the comparison of step 243. that a user of a mobile device is in said environment when the mobile device has an absolute location in a predefined spatial area around the absolute location of the environment.

Step 103 comprises, if multiple users are detected to be in said environment in step 101, determining which user of the multiple users is nearest to the system based on shortrange wireless signals received from mobile devices of the multiple users.

Step 105 comprises retrieving a user profile associated with the user nearest to the system, as determined in step 103. The user profile specifies user preferences. Step 107 comprises determining the light effects based on the media content and the user preferences retrieved in step 105. Step 109 comprises controlling the one or more lighting devices to render the light effects determined in step 107.

A sixth embodiment of the method of controlling one or more lighting devices to render light effects determined based on media content to accompany a rendering of the media content is shown in FIG. 9. The method may be performed by the HDMI module 1 of FIG. 1 or the lighting system 41 of FIG. 3, for example.

Step 101 comprises detecting whether one or more users are in said environment. Step 101 is implemented by steps 261, 263, and 265. Step 261 comprises identifying a (home) network to which the system is connected. Step 263 comprises detecting whether one or more of a plurality of mobile devices are connected to the (home) network identified in step 261. Step 265 comprises determining, based on the results of step 263, that a user of a mobile device is in said environment when the mobile device is connected to the (home) network.

Step 103 comprises, if multiple users are detected to be in said environment in step 101, determining which user of the multiple users is nearest to the system based on shortrange wireless signals received from mobile devices of the multiple users.

Step 105 comprises retrieving a user profile associated with the user nearest to the system, as determined in step 103. The user profile specifies user preferences. Step 107 comprises determining the light effects based on the media content and the user preferences retrieved in step 105. Step 109 comprises controlling the one or more lighting devices to render the light effects determined in step 107.

The embodiments of FIGS. 4 to 9 differ from each other in multiple aspects, i.e., multiple steps have been added or replaced. In variations on these embodiments, only a subset of these steps is added or replaced and/or one or more steps is omitted. For example, example, steps 163-167 may be omitted from the embodiment of FIG. 5 and/or added to one or more of the embodiments of FIG. 4 and FIGS. 6 to 9. Moreover, one or more of the embodiments of FIGS. 4 to 9 may be combined. For example, the embodiments of FIGS. 4 to 7 may be combined with the embodiment of FIG. 8 or FIG. 9.

FIG. 10 depicts a block diagram illustrating an exemplary data processing system that may perform the method as described with reference to FIGS. 4 to 9.

As shown in FIG. 10, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g., for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 10 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 10, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 10) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for controlling one or more lighting devices to render light effects determined based on media content to accompany a rendering of said media content, said system comprising;
at least one receiver; at least one transmitter; and at least one processor configured to:
detect whether one or more users are in an environment;
if multiple users are detected to be in the environment, determine which user of said multiple users is nearest to said system based on shortrange wireless signals received, via said at least one receiver, from mobile devices of said multiple users,
retrieve, from a memory, a user profile associated with said user nearest to said system, said user profile specifying user preferences,
determine said light effects based on said media content and said user preferences, and
control, via said at least one transmitter said one or more lighting devices to render said light effects.

2. A system as claimed in claim 1, wherein said at least one processor is configured to:
receive, via said at least one receiver, absolute locations of a plurality of mobile devices,
compare said absolute locations of said plurality of mobile devices with an absolute location of said environment, and
for each mobile device of said plurality of mobile devices which has an absolute location in a predefined spatial area around said absolute location of said environment, determine that a user of said mobile device is at home.

3. A system as claimed in claim 1, wherein said at least one processor is configured to:
identify a network to which said system is connected,
detect whether one or more of a plurality of mobile devices are connected to said network, and
for each mobile device of said plurality of mobile devices which is connected to said network, determine that a user of said mobile device is in said environment.

4. A system as claimed in claim 1, wherein said at least one processor is configured to:
determine a signal strength of each of said shortrange wireless signals received from said mobile devices of said multiple users,
select a mobile device from said mobile devices of said multiple users, said signal received from said selected mobile device having a highest signal strength of said signal strengths, and
determine that a user of said selected mobile device is nearest to said system.

5. A system as claimed in claim 1, wherein said at least one processor is configured to:
receive, via said at least one receiver, a control signal from a further mobile device of a further user of said multiple users, said control signal comprising a command to start rendering said light effects,
select said further user instead of said user nearest to said system,
retrieve a further user profile associated with said further user, said further user profile specifying further user preferences,
determine said light effects based on said media content and said further user preferences, and
control, via said at least one transmitter, said one or more lighting devices to render said light effects.

6. A system as claimed in claim 1, wherein said at least one processor is configured to transmit, via said at least one transmitter, a notification to a mobile device of said user nearest to said system, said notification notifying said user that said user's user profile is now active.

7. A system as claimed in claim 6, wherein said at least one processor is configured to:
receive, via said at least one receiver, a second control signal from said mobile device of said user nearest to said system, said second control signal identifying another user,
select said other user instead of said user nearest to said system,
retrieve another user profile associated with said other user, said other user profile specifying other user preferences,
determine said light effects based on said media content and said other user preferences, and
control, via said at least one transmitter said one or more lighting devices to render said light effects.

8. A system as claimed in claim 1, wherein said user preferences indicate one or more of: a level of dynamicity of said light effects, a light output level of said light effects, a minimum light output level, said one or more lighting devices to be used for rendering said light effects, and a source which provides said media content.

9. A system as claimed in claim 1, wherein said user profile specifies user preferences per content type and said at least one processor is configured to:
obtain a content type of said media content,
select user preferences associated with said content type from said user profile, and
determine said light effects based on said media content and said user preferences associated with said content type.

10. A system as claimed in claim 1, wherein said at least one processor is configured to:
receive a configuration signal from said mobile device of said user nearest to said system, said configuration signal indicating an adjustment to said user preferences,
adjust said user preferences in said user profile based on said configuration signal,
determine said light effects based on said media content and said adjusted user preferences, and
replace said user profile with said adjusted user profile in said memory

11. A system as claimed in claim 1, wherein said at least one processor is configured to:
receive, via said at least one receiver, a device identifier of said mobile device of said user nearest to said system, and
retrieve said user profile associated with said user by retrieving a user profile associated with said device identifier.

12. A system as claimed in claim 1, wherein said shortrange wireless signals are Bluetooth signals or Zigbee signals.

13. A method of controlling one or more lighting devices to render light effects determined based on media content to accompany a rendering of said media content, said method comprising:
detecting whether one or more users are in an environment;
if multiple users are detected to be in said environment, determining which user of said multiple users is nearest to said system based on shortrange wireless signals received from mobile devices of said multiple users;
retrieving a user profile associated with said user nearest to said system, said user profile specifying user preferences;
determining said light effects based on said media content and said user preferences; and
controlling said one or more lighting devices to render said light effects.

14. A computer program product for a computing device, the computer program product comprising computer program code to perform the method of claim 13 when the computer program product is run on a processing unit of the computing device.
